(19) United States
(12) Patent Application Publication
(10) Pub. No.: US 2020/0285859 A1
(43) Pub. Date: Sep. 10, 2020

(54) VIDEO SUMMARY GENERATION METHOD AND APPARATUS, ELECTRONIC DEVICE, AND COMPUTER STORAGE MEDIUM

(71) Applicant: SHENZHEN SENSETIME TECHNOLOGY CO., LTD., Shenzhen (CN)

(72) Inventors: Litong FENG, Shenzhen (CN); Da XIAO, Shenzhen (CN); Zhanghui KUANG, Shenzhen (CN); Wei ZHANG, Shenzhen (CN)

(21) Appl. No.: 16/884,177

(22) Filed: May 27, 2020

Related U.S. Application Data
(63) Continuation of application No. PCT/CN2019/088020, filed on May 22, 2019.

(30) Foreign Application Priority Data
Oct. 19, 2018 (CN) 201811224169.X

(51) Int. Cl. G06K 9/00; G06K 9/62; H04N 21/8549; G06N 3/04; G06N 3/08

(52) U.S. Cl. CPC G06K 9/00751; G06K 9/6232; G06K 9/00765; G06K 9/00758; G06N 3/08; G06K 9/6256; H04N 21/8549; G06N 3/0454; G06K 9/6215

(57) ABSTRACT

A video summary generation method and apparatus, an electronic device, and a computer storage medium are provided. The method includes: performing feature extraction on each shot in a shot sequence of a video stream to be processed, to obtain an image feature of the shot, each shot including at least one frame of video image; obtaining a global feature of the shot according to all image features of the shot; determining a weight of the shot according to the image feature of the shot and the global feature; and obtaining a video summary of the video stream to be processed based on the weight of the shot.

### CROSS-REFERENCE TO RELATED APPLICATION

The present disclosure is a U.S. continuation application of International Application No. PCT/CN2019/088020, filed on May 22, 2019, which claims priority to Chinese Patent Application No. 201811224169.X, filed to the Chinese Patent Office on Oct. 19, 2018. The disclosures of International Application No. PCT/CN2019/088020 and Chinese Patent Application No. 201811224169.X are incorporated herein by reference in their entireties.

### BACKGROUND

With the rapid increase of video data, in order to quickly browse these videos in a short period of time, video summary has started to play an increasingly important role. The video summary relates to an emerging video understanding technology, and is to extract some shots from a longer video to synthesize a shorter new video that contains the story line or wonderful shots in the original video.

The artificial intelligence technology has been well solved for many computer vision problems, such as image classification. The performance of artificial intelligence has even surpassed humans, but this is just limited to some areas with clear goals. Compared with other computer vision tasks, the video summary is more abstract and puts greater emphasis on the overall understanding of the entire video. The selection to a shot in the video summary depends not only on information of the shot per se, but also on information expressed by the entire video.

### SUMMARY

The present disclosure relates to, but is not limited to, computer vision technologies, and in particular, to a video summary generation method and apparatus, an electronic device, and a computer storage medium.

Embodiments of the present disclosure provide a video summary generation method and apparatus, an electronic device, and a computer storage medium.

A video summary generation method provided according to one aspect of the embodiments of the present disclosure includes:

performing feature extraction on each shot in a shot sequence of a video stream to be processed, to obtain an image feature of the shot, the shot including at least one frame of video image;

obtaining a global feature of the shot according to all image features of the shot;

determining a weight of the shot according to the image feature of the shot and the global feature; and

obtaining a video summary of the video stream to be processed based on the weight of the shot.

A video summary generation apparatus provided according to another aspect of the embodiments of the present disclosure includes:

a feature extraction unit, configured to perform feature extraction on each shot in a shot sequence of a video stream to be processed, to obtain an image feature of the shot, the shot including at least one frame of video image;

a global feature unit, configured to obtain a global feature of the shot according to all image features of the shot;

a weight obtaining unit, configured to determine a weight of the shot according to the image feature of the shot and the global feature; and

a summary generation unit, configured to obtain a video summary of the video stream to be processed based on the weight of the shot.

An electronic device provided according to still another aspect of the embodiments of the present disclosure includes a processor, where the processor includes the video summary generation apparatus according to any one of the foregoing embodiments.

An electronic device provided according to yet another aspect of the embodiments of the present disclosure includes: a memory, configured to store executable instructions; and

a processor, configured to communicate with the memory to execute the executable instructions so as to complete operations of the video summary generation method according to any one of the foregoing embodiments.

A computer storage medium provided according to yet another aspect of the embodiments of the present disclosure is configured to store computer readable instructions, where when the instructions are executed, operations of the video summary generation method according to any one of the foregoing embodiments are executed.

A non-transitory computer program product provided according to another aspect of the embodiments of the present disclosure includes a computer readable code, where when the computer readable code runs on a device, a processor in the device executes instructions for implementing the video summary generation method according to any one of the foregoing embodiments.

The technical solutions of the present disclosure are further described in detail with reference to the accompanying drawings and embodiments as follows

### BRIEF DESCRIPTION OF THE ACCOMPANYING DRAWINGS

The accompanying drawings constituting a part of the specification describe embodiments of the present disclosure and are intended to explain the principles of the present disclosure together with the descriptions.

According to the following detailed descriptions, the present disclosure can be understood more clearly with reference to the accompanying drawings.

FIG. 1 is a schematic flowchart of one embodiment of a video summary generation method provided in embodiments of the present disclosure.

FIG. 2 is a schematic flowchart of another embodiment of a video summary generation method provided in embodiments of the present disclosure.

FIG. 3 is part of a schematic flowchart of an optional example of a video summary generation method provided in embodiments of the present disclosure.

FIG. 4 is part of a schematic flowchart of another optional example of a video summary generation method provided in embodiments of the present disclosure.

FIG. 5 is a schematic flowchart of another embodiment of a video summary generation method provided in embodiments of the present disclosure.

FIG. 6 is a diagram of some optional examples of a video summary generation method provided in embodiments of the present disclosure.

FIG. 7 is a schematic flowchart of another embodiment of a video summary generation method provided in embodiments of the present disclosure.

FIG. 8 is part of a schematic flowchart of still another optional example of a video summary generation method provided in embodiments of the present disclosure.

FIG. 9 is a schematic structural diagram of one embodiment of a video summary generation apparatus provided in embodiments of the present disclosure.

FIG. 10 is a schematic structural diagram of an electronic device suitable for implementing a terminal device or a server in embodiments of the present disclosure.

### DETAILED DESCRIPTION

Based on a video summary generation method and apparatus, an electronic device, and a computer storage medium provided in the embodiments of the present disclosure, feature extraction is performed on a shot in a shot sequence of a video stream to be processed to obtain an image feature of the shot, each shot including at least one frame of video image; a global feature of the shot is obtained according to all image features of the shot; a weight of the shot is determined according to the image feature of the shot and the global feature; and a video summary of the video stream to be processed is obtained based on the weight of the shot. The weight of each shot is determined in combination of the image feature and the global feature, such that a video is understood on the part of the video as a whole; and by using the global relationship between each shot and the video, based on the video summary determined based on the weight of the shot in some embodiments, the video content can be expressed as a whole, thereby reducing the issue of an one-sided video summary.

Various exemplary embodiments of the present disclosure are now described in detail with reference to the accompanying drawings. It should be noted that, unless otherwise stated specifically, relative arrangement of the components and operations, numerical expressions, and values set forth in some embodiments are not intended to limit the scope of the present disclosure.

In addition, it should be understood that, for ease of description, the size of each part shown in the accompanying drawings is not drawn in actual proportion.

The following descriptions of at least one exemplary embodiment are merely illustrative actually, and are not intended to limit the present disclosure and disclosures or uses thereof.

Technologies, methods and devices known to a person of ordinary skill in the related art may not be discussed in detail, but such technologies, methods and devices should be considered as a part of the specification in appropriate situations.

It should be noted that similar reference numerals and letters in the following accompanying drawings represent similar items. Therefore, once an item is defined in an accompanying drawing, the item does not need to be further discussed in the subsequent accompanying drawings.

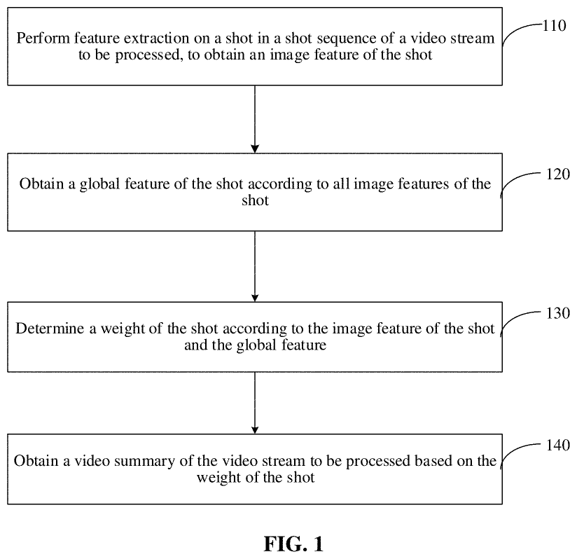

FIG. 1 is a schematic flowchart of one embodiment of a video summary generation method provided in embodiments of the present disclosure. The method may be executed by any video summary extraction devices, such as a terminal device, a server, and a mobile device. As shown in FIG. 1, the method of the embodiment includes the following operations.

At operation 110, feature extraction is performed on a shot in a shot sequence of a video stream to be processed, to obtain an image feature of the shot.

Video summary relates to: extracting key information or main information from an original video stream to generate a video summary, where the video summary is smaller than the original video stream in data flow, covers the main content or key content of the original video stream, and thus can be used for subsequent retrieval or the like for the original video stream.

In some embodiments, for example, a video summary representable of a motion trajectory of a particular target in a video stream is generated by analyzing a motion change of the same target in the video stream. Of course, this is only an example, and the specific implementation is not limited to the foregoing example.

In some embodiments, the video stream to be processed is a video stream from which the video summary is obtained, and the video stream includes at least one frame of video image. In order to make the obtained video summary have meaningful content, instead of being just an image set consisting of different frames of video images, in some embodiments of the present disclosure, the shot is used as a constituent unit of the video summary, and each shot includes at least one frame of video image.

In some embodiments, the feature extraction in some embodiments of the present disclosure may be implemented based on any feature extraction network, i.e., the feature extraction is separately performed on each shot based on a feature extraction network to obtain at least two image features. A specific feature extraction process is not limited in the present disclosure.

At operation 120, a global feature of the shot is obtained according to all image features of the shot.

In some embodiments, all the image features corresponding to the video stream are processed (such as mapping or embedding) to obtain a conversion feature sequence corresponding to the entire video stream, the conversion feature sequence is then calculated together with each image feature to obtain the global feature (global attention) corresponding to each shot, and an association between each shot and the other shots in the video stream can be reflected through the global feature.

The global feature here includes, but is not limited to: an image feature representing a correspondence or a positional relationship between the same image element in multiple video images in one shot. It should be noted that the foregoing association is limited to the correspondence and/or the positional relationship.

At operation 130, a weight of the shot is determined according to the image feature of the shot and the global feature.

The weight of the shot is determined through the image feature of the shot and the global feature of the shot. The weight obtained thereby is based not only on the shot per se, but also on the association between the shot and the other shots in the entire video stream, thereby achieving evaluation on the importance of the video on the part of the video as a whole.

At operation 140, a video summary of the video stream to be processed is obtained based on the weight of the shot.

In some embodiments, the importance of a shot in the shot sequence is determined through the value of the weight of the shot. However, the video summary is determined not just based on the importance of the shot, it further requires to control the length of the video summary, i.e., it requires to determine the video summary in combination with the weight of the shot and the duration of the shot (number of frames). Specifically, for example, the weight is positively correlated to the importance of the shot and/or the length of the video summary In some embodiments, the video summary may be determined by using a knapsack algorithm or other algorithms, which are not to be listed.

According to the video summary generation method provided in the foregoing embodiments, feature extraction is performed on a shot in a shot sequence of a video stream to be processed to obtain an image feature of the shot, each shot including at least one frame of video image; a global feature of the shot is obtained according to all image features of the shot; a weight of the shot is determined according to the image feature of the shot and the global feature; and a video summary of the video stream to be processed is obtained based on the weight of the shot. The weight of each shot is determined in combination of the image feature and the global feature, such that a video is understood on the part of the video as a whole; and by using the global association between each shot and the entire video, based on the video summary determined in some embodiments, the video content can be expressed as a whole, thereby reducing the issue of an one-sided video summary.

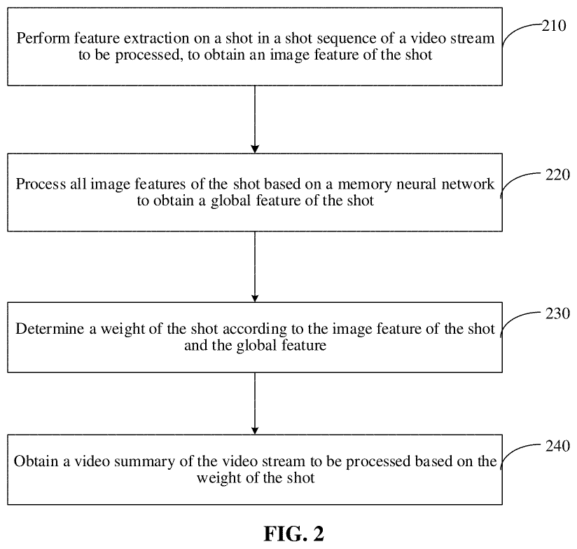

FIG. 2 is a schematic flowchart of another embodiment of a video summary generation method provided in embodiments of the present disclosure. As shown in FIG. 2, the method of the embodiment includes the following operations.

At operation 210, feature extraction is performed on a shot in a shot sequence of a video stream to be processed, to obtain an image feature of the shot.

Operation 210 in some embodiments of the present disclosure is similar to operation 110 in the foregoing embodiments, and thus the operation can be understood with reference to the foregoing embodiments, and details are not described herein again.

At operation 220, all image features of the shot are processed based on a memory neural network to obtain a global feature of the shot.

In some embodiments, the memory neural network may include at least two embedding matrices. By respectively inputting the all image features of the shot of the video stream to the at least two embedding matrices, the global feature of each shot is obtained through an output of the embedding matrices. The global feature of the shot may reflect an association between the shot and the other shots in the video stream. In terms of a weight of the shot, the greater the weight, the greater the association between the shot and the other shots, and the more likely the shot is to be included in the video summary.

At operation 230, the weight of the shot is determined according to the image feature of the shot and the global feature.

Operation 230 in some embodiments of the present disclosure is similar to operation 130 in the foregoing embodiments, and thus the operation can be understood with reference to the foregoing embodiments, and details are not described herein again.

At operation 240, a video summary of the video stream to be processed is obtained based on the weight of the shot.

Operation 240 in some embodiments of the present disclosure is similar to operation 140 in the foregoing embodiments, and thus the operation can be understood with reference to the foregoing embodiments, and details are not described herein again.

In some embodiments of the present disclosure, a memory neural network imitates how humans create a video summary, i.e., a video is understood on the part of the video as a whole, information on an entire video stream is stored by using the memory neural network, and the importance of each shot is determined by using a global relationship between the shot and the video, so that the shot as the video summary is selected.

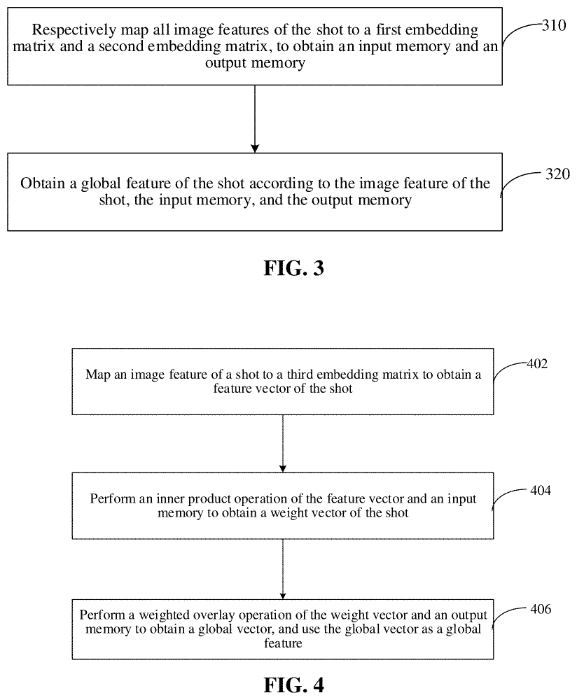

FIG. 3 is part of a schematic flowchart of an optional example of a video summary generation method provided in embodiments of the present disclosure. As shown in FIG. 3, operation 220 in the foregoing embodiments includes the following operations.

At operation 310, all image features of the shot are respectively mapped to each of a first embedding matrix and a second embedding matrix, to obtain a respective one of an input memory and an output memory. That is, all image features of the shot are mapped to a first embedding matrix to obtain an input memory and all image features of the shot are mapped to a second embedding matrix to obtain an output memory.

The input memory and the output memory in some embodiments respectively correspond to all the shots of a video stream. Each embedding matrix corresponds to one memory (input memory or output memory), and one group of new image features, i.e., one memory, can be obtained by mapping the all image features of the shot to one embedding matrix.

At operation 320, a global feature of a shot is obtained according to the image feature of the shot, the input memory, and the output memory.

The global feature of the shot can be obtained by combining the input memory and the output memory with the image feature of the shot. The global feature reflects an association between the shot and all the other shots in the video stream, so that a weight of the shot obtained based on the global feature is correlated to the video stream as whole, so as to obtain a more comprehensive video summary.

In one or more embodiments, each shot may correspond to at least two global features, the at least two global features may be obtained through at least two embedding matrix groups, and the structure of each embedding matrix group is similar to that of the first and second embedding matrices in the foregoing embodiments;

the image features of the shots are respectively mapped to the at least two embedding matrix groups, to obtain at least two memory groups, each embedding matrix group including two embedding matrices, and each memory group including the input memory and the output memory; and

the at least two global features of the shot are obtained according to the at least two memory groups and the image feature of the shot.

In some embodiments of the present disclosure, in order to improve the globality of a weight of a shot, at least two global features are obtained through at least two memory groups, and the weight of the shot is obtained in combination of multiple global features, where each embedding matrix group includes different embedding matrices or the same embedding matric, and when the embedding matrix groups are different, the obtained global features can better reflect a global association between the shot and a video.

FIG. 4 is part of a schematic flowchart of another optional example of a video summary generation method provided in embodiments of the present disclosure. As shown in FIG. 4, operation 320 in the foregoing embodiments includes the following operations.

At operation 402, an image feature of a shot is mapped to a third embedding matrix to obtain a feature vector of the shot.

In some embodiments, the third embedding matrix can implement conversion of an image feature, i.e., converting the image feature of the shot to obtain the feature vector of the shot, for example, an image feature uᵢ corresponding to the ith shot in a shot sequence is converted to obtain a feature vector uᵢ^{T}.

At operation 404, an inner product operation of the feature vector and an input memory is performed to obtain a weight vector of the shot.

In some embodiments, the input memory corresponds to the shot sequence, and therefore, the input memory includes at least two vectors (the number corresponds to the number of shots). When the inner product operation of the feature vector and the input memory is performed, a result of inner product calculation for the feature vector and a plurality of vectors in the input memory can be mapped to an interval (0, 1) through a Softmax activation function, so as to obtain a plurality of values expressed in the form of probability, and the plurality of values expressed in the form of probability are used as the weight vector of the shot. For example, a weight vector can be obtained through formula (1):

pᵢ=Softmax(uᵢ^{T}a) (1),

where uᵢ represents the image feature of the ith shot, i.e., the image feature corresponding to the current shot of which the weight needs to be calculated; a represents the input memory; pᵢ represents the weight vector of an association between the ith image feature and the input memory; the Softmax activation function is used for outputting a plurality of nerve cells in a multi-classification process and mapping same to the interval (0, 1), which can be understood as probability; the value of i is the number of the shots in the shot sequence; and the weight vector indicating the association between the ith image feature and the shot sequence can be obtained through formula (1).

At operation 406, a weighted overlay operation of the weight vector and an output memory is performed to obtain a global vector, and the global vector is used as the global feature.

In some embodiments, the global vector is obtained through the following formula (2):

oᵢ=Σᵢpᵢ^{b} (2),

where b represents the output memory obtained based on a second embedding matrix; and oᵢ represents the global vector calculated from the ith image feature and the output memory.

In some embodiments, an inner product operation of an image feature and an input memory is performed to obtain an association between the image feature and each shot. Optionally, before performing the inner product operation, the image feature can be converted to ensure that the inner product operation of the image feature and vectors in the input memory can be performed, at which time, an obtained weight vector includes a plurality of probability values, where each probability value represents the association between the shot and each of the other shots in the shot sequence, and the greater the probability, the stronger the association; and the inner product operation of each probability value and a plurality of vectors in an output memory is separately performed to obtain a global vector of the shot as a global feature.

In one embodiment, each shot corresponds to at least two global features, and the obtaining the at least two global features of the shot according to at least two memory groups includes:

mapping the image feature of the shot to the third embedding matrix to obtain the feature vector of the shot;

performing the inner product operation of the feature vector and at least two input memories to obtain at least two weight vectors of the shot; and

performing the weighted overlay operation of the weight vectors and at least two output memories to obtain at least two global vectors, and using the at least two global vectors as the at least two global features.

The processes of calculating each weight vector and each global vector are similar to those in the foregoing embodiments, and thus can be understood with reference to the foregoing embodiments, and details are not described herein again. Optionally, the formula of obtaining the weight vector can be obtained by transforming the formula (1) above as formula (5):

pᵢ^{k}=Softmax(uᵢ^{T}aₖ) (5)

where uᵢ represents the image feature of the ith shot, i.e., the image feature corresponding to the current shot of which the weight needs to be calculated; uᵢ^{T} represents the feature vector of the ith shot; aₖ represents the input memory in the kth memory group; pᵢ^{k} represents the weight vector of an association between the ith image feature and the input memory in the kth memory group; the Softmax activation function is used for outputting a plurality of nerve cells in a multi-classification process and mapping same to the interval (0, 1), which can be understood as probability; the value of k is 1 to N; and the at least two weight vectors indicating the association between the ith image feature and the shot sequence can be obtained through formula (5).

In some embodiments, the at least two global vectors in the embodiment are obtained by transforming the formula (2) as formula (6):

oᵢ^{k}=Σᵢ^{k}bₖ (6),

where bₖ represents the output memory in the kth memory group; oᵢ^{k} represents the global vector calculated from the ith image feature and the output memory in the kth memory group; and the at least two global vectors of the shot can be obtained through formula (6).

FIG. 5 is a schematic flowchart of another embodiment of a video summary generation method provided in embodiments of the present disclosure. As shown in FIG. 5:

At operation 510, feature extraction is performed on a shot in a shot sequence of a video stream to be processed, to obtain an image feature of the shot.

Operation 510 in some embodiments of the present disclosure is similar to operation 110 in the foregoing embodiments, and thus the operation can be understood with reference to the foregoing embodiments, and details are not described herein again.

At operation 520, a global feature of the shot is obtained according to all image features of the shot.

Operation 520 in some embodiments of the present disclosure is similar to operation 120 in the foregoing embodiments, and thus the operation can be understood with reference to any of the foregoing embodiments, and details are not described herein again.

At operation 530, an inner product operation of the image feature of the shot and the global feature of the shot is performed to obtain a weight feature.

In some embodiments, the inner product operation of the image feature of the shot and the global feature of the shot is performed, so that the obtained weight feature also depends on information of the shot per se, while reflecting the importance of the shot in an entire video. Optionally, the weight feature can be obtained through formula (3):

u′ᵢ=uᵢ⊙oᵢ (3),

where u′ᵢ represents the weight feature of the ith shot; oᵢ represents the global vector of the ith shot; and ⊙ represents a dot product, i.e., the inner product operation.

At operation 540, the weight feature passes through a fully connected neural network to obtain a weight of the shot.

The weight is used for reflecting the importance of the shot, and thus it needs to be expressed in numerical form. Optionally, in some embodiments, the dimension of the weight feature is converted through the fully connected neural network to obtain a weight of the shot expressed as a one-dimensional vector.

In some embodiments, the weight of the shot can be obtained based on the following formula (4):

sᵢ=W_{D}·u′ᵢ+b_{D} Formula (4),

where sᵢ represents the weight of the ith shot; and W_{D} and b₀ respectively represent the weight and an offset of a target image feature passing through the fully connected network.

At operation 550, a video summary of the video stream to be processed is obtained based on the weight of the shot.

In some embodiments, a weight of a shot is determined in combination with an image feature of the shot and a global feature of the shot, and when information of the shot is reflected, it also combines the association between the shot and a video as a whole, so that the video is understood on the part of the video partially or as a whole, thereby making the obtained video summary more in line with human habits.

In some embodiments, the determining the weight of the shot according to the image feature of the shot and the global feature includes:

performing the inner product operation of the image feature of the shot and a first global feature in the at least two global features of the shot to obtain a first weight feature;

using the first weight feature as the image feature, and using a second global feature in the at least two global features of the shot as a first global feature, the second global feature being a global feature other than the first global feature in the at least two global features;

performing the inner product operation of the image feature of the shot and the first global feature in the at least two global features of the shot to obtain the first weight feature;

using the first weight feature as the weight feature of the shot when the at least two global features of the shot do not include the second global feature; and

passing the weight feature through the fully connected neural network to obtain the weight of the shot.

In some embodiments, since there is a plurality of global features, each time the result of the inner product operation of the image feature and the global feature is used as the image feature of the next operation to implement a loop, and each operation can be implemented based on formula (7) transformed from the formula (3):

u′ᵢ=uᵢ⊙oᵢ^{k} (7)

where oᵢ^{k} represents the global vector calculated from the ith image feature and the output memory in the kth memory group; u′ᵢ represents the first weight feature; ⊙ represents the dot product. When the loop goes to the (k+1)th memory group and the global vector is calculated from the output memory therein, uᵢ is replaced with u′ᵢ to represent the image feature of the ith shot, at which time, oᵢ^{k} is replaced with oᵢ^{k+1} until the operation of the memory group is completed, and the output u′ᵢ is used as the weight feature of the shot. The determination of the weight of the shot through the weight feature is similar to that in the foregoing embodiments, and details are not described herein again.

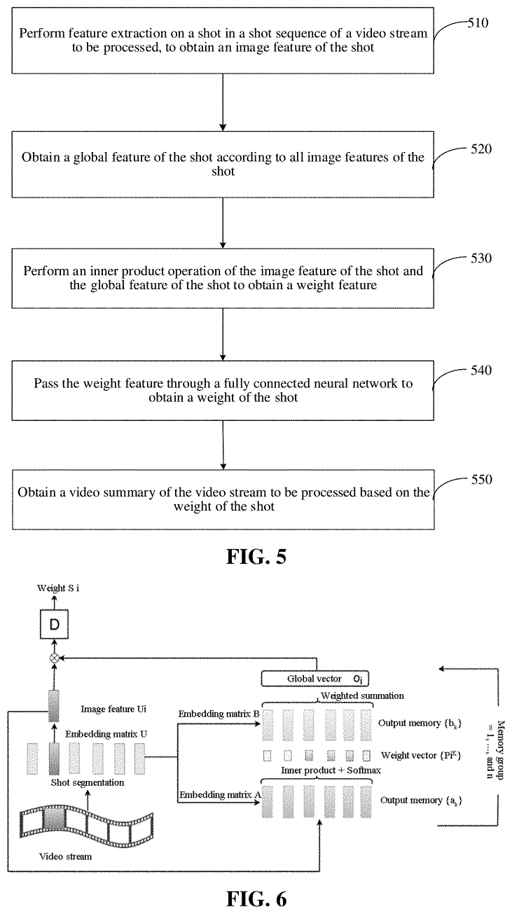

FIG. 6 is a diagram of some optional examples of a video summary generation method provided in embodiments of the present disclosure. As shown in FIG. 6, the present example includes a plurality of memory groups, where the number of the memory groups is n; a plurality of matrices is obtained by segmenting a video stream, and a weight sᵢ of the ith shot can be obtained in combination of an image feature and formulas (5), (6), (7), and (4). Refer to the description of the foregoing embodiments for the specific process of obtaining the weight, and details are not described here again.

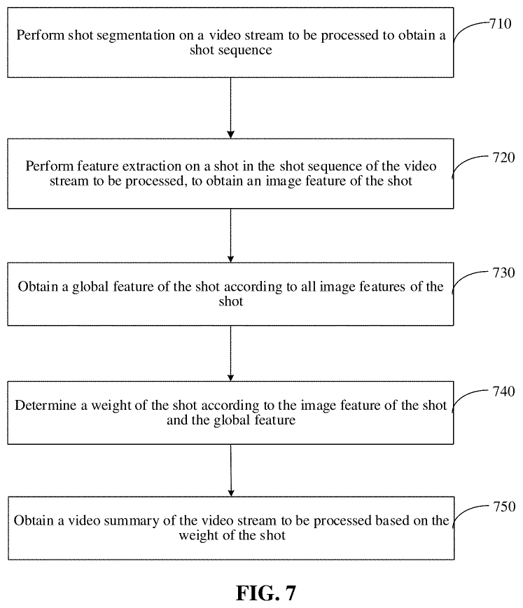

FIG. 7 is a schematic flowchart of another embodiment of a video summary generation method provided in embodiments of the present disclosure. As shown in FIG. 7, the method of the embodiment includes the following operations.

At operation 710, shot segmentation is performed on a video stream to be processed to obtain a shot sequence.

In some embodiments, shot segmentation is performed based on the similarity between at least two frames of video images in the video stream to be processed, to obtain the shot sequence.

In some embodiments, the similarity between two frames of video images can be determined through a distance (such as Euclidean distance and Cosine distance) between features corresponding to the two frames of video images. The higher the similarity between the two frames of video images, the more likely the two frames of video images belong to the same shot. In some embodiments, video images which are significantly different can be segmented to different shots though the similarity between the video images, thereby achieving accurate shot segmentation.

At operation 720, feature extraction is performed on a shot in the shot sequence of the video stream to be processed, to obtain an image feature of the shot.

Operation 720 in some embodiments of the present disclosure is similar to operation 110 in the foregoing embodiments, and thus the operation can be understood with reference to any of the foregoing embodiments, and details are not described herein again.

At operation 730, a global feature of the shot is obtained according to all image features of the shot.

Operation 730 in some embodiments of the present disclosure is similar to operation 120 in the foregoing embodiments, and thus the operation can be understood with reference to any of the foregoing embodiments, and details are not described herein again.

At operation 740, a weight of the shot is determined according to the image feature of the shot and the global feature.

Operation 740 in some embodiments of the present disclosure is similar to operation 130 in the foregoing embodiments, and thus the operation can be understood with reference to any of the foregoing embodiments, and details are not described herein again.

At operation 750, a video summary of the video stream to be processed is obtained based on the weight of the shot.

Operation 750 in some embodiments of the present disclosure is similar to operation 140 in the foregoing embodiments, and thus the operation can be understood with reference to any of the foregoing embodiments, and details are not described herein again.

In some embodiments of the present disclosure, a shot is used as a unit for summary extraction. First, it needs to obtain at least two shots based on a video stream. A method for shot segmentation can be implemented through methods such as segmentation of a neural network or a known photographing lens or human judgment. The specific means for shot segmentation is not limited in some embodiments of the present disclosure.

FIG. 8 is part of a schematic flowchart of still another optional example of a video summary generation method provided in embodiments of the present disclosure. As shown in FIG. 8, operation 710 in the foregoing embodiments includes the following operations.

At operation 802, video images in a video stream are segmented based on each of at least two segmentation intervals of different sizes, to obtain a respective one of at least two video segment groups. For example, if the at least two segmentation intervals of different sizes includes segmentation interval of size 1 and segmentation interval of size 2, video images in a video stream are segmented based on segmentation interval of size 1 to obtain video segment group 1, and video images in a video stream are segmented based on segmentation interval of size 2 to obtain video segment group 2.

Each video segment group includes at least two video segments, and the segmentation interval is greater than or equal to one frame.

In some embodiments of the present disclosure, the video stream is segmented through a plurality of segmentation intervals of different sizes, for example, the segmentation intervals are respectively one frame, four frames, six frames, eight frames, etc.; the video stream can be segmented into a plurality of video segments of a fixed size (such as six frames) through one segmentation interval.

At operation 804, whether the segmentation is correct is determined based on the similarity between at least two break frames in each video segment group.

The break frame is a first frame in the video segment; and optionally, in response to that the similarity between the at least two break frames is less than or equal to a set value, the segmentation is determined to be correct; and in response to that the similarity between the at least two break frames is greater than the set value, the segmentation is determined to be incorrect.

In some embodiments, an association between two frames of video images can be determined based on the similarity between features, and the greater the similarity, the more likely it is the same shot. In terms of photographing, there are two types of scene switching, one is to switch a scene directly through a shot, and the other is to gradually change the scene through a long shot. The embodiments of the present disclosure mainly use the change of the scene as the basis for shot segmentation; that is, even for a video segment photographed in the same long shot, when the association between the image of a certain frame and the first frame of image of the long shot is less than or equal to the set value, the shot is also segmented.

At operation 806, in response to that the segmentation is correct, the video segments are determined as the shots to obtain a shot sequence.

In some embodiments of the present disclosure, a video stream is segmented through a plurality of segmentation intervals of different sizes, and then the similarity between break frames of two continuous video segments is determined, so as to determine whether the segmentation at the position is correct, where when the similarity between the two continuous break frames exceeds a certain value, it indicates that the segmentation at the position is incorrect, i.e., the two video segments belong to the same shot. A shot sequence can be obtained through correct segmentation.

In some embodiments, operation 806 includes:

in response to that the break frames correspond to the at least two segmentation intervals, using the video segments obtained with the smaller segmentation interval as the shots to obtain the shot sequence.

When a break frame at a break position is a port segmented based on at least two segmentation intervals, for example, for a video stream including eight frames of images, two frames and four frames are respectively used as a first segmentation interval and a second segmentation interval. Four video segments are obtained based on the first segmentation interval, where the first frame, the third frame, the fifth frame, and the seventh frame are break frames, and two video segments are obtained based on the second segmentation interval, where the first frame and the fifth frame are break frames. At that time, if it is determined that the segmentation corresponding to the break frames, i.e., the fifth frame and the seventh frame, is correct, the fifth frame is the break frame of the first segmentation interval and is also the break frame of the second segmentation interval. In that case, it is based on the first segmentation interval, i.e., three shots are obtained by segmenting the video stream: frames 1 to 4 are one shot, frames 5 and 6 are one shot, and frames 7 and 8 are one shot; on the contrary, frame 5 to 8 are not taken as a shot according to the second segmentation interval.

In one or more embodiments, operation 110 includes:

performing feature extraction on at least one frame of video image in the shot to obtain at least one image feature; and

obtaining a mean feature of all the image features, and using the mean feature as the image feature of the shot.

In some embodiments, the feature extraction is separately performed on each frame of video image in the shot through a feature extraction network. When one shot includes only one frame of video image, the image feature is used as the image feature, and when multiple frames of video images are included, a means of the multiple image features is calculated, and a mean feature is used as the image feature of the shot.

In one or more embodiments, operation 140 includes the following operations.

(1) A limited duration of the video summary is obtained.

Video summary, also known as video synthesis, is a brief summary of video content. It can reflect the main content expressed in a video in a short period of time. It is necessary to limit the duration of the video summary while expressing the main content of the video, otherwise, the brief effect will not be yielded and there is no difference from watching the full video. In some embodiments of the present disclosure, the duration of the video summary is limited through a limited duration, i.e., the duration of the obtained video summary is required to be less than or equal to the limited duration, and the specific value of the limited duration can be set according to an actual situation.

(2) The video summary of the video stream to be processed is obtained according to the weight of the shot and the limited duration of the video summary.

In some embodiments, the embodiments of the present disclosure achieve extraction of the video summary through the 01 knapsack algorithm, where when disclosure is made the present embodiments, the problem solved by the 01 knapsack algorithm can be described as: how to ensure that the video summary has the largest total weight within the limited duration, in the case that the shot sequence includes a plurality of shots, and each shot has a corresponding (usually different) length, each shot has a corresponding (usually different) weight, and the video summary of the limited duration needs to be obtained. Therefore, the embodiments of the present disclosure can obtain the video summary of the best content through the knapsack algorithm. At that time, there is also a special case: in response to obtaining a shot of which the length is greater than a second set frame number in at least two shots with the highest weight, deleting the shot of which the length is greater than the second set frame number. When an importance score of a certain obtained shot is high, but the length thereof is already greater than the second set frame number (for example, the half of a first set frame number), if the shot is still added to the video summary, it will result in too little content in the video summary. Therefore, the shot is not added in the video summary.

In one or more optional embodiments, the method of the embodiments of the present disclosure is implemented based on the feature extraction network and the memory neural network; and

Before the execution of operation 1190, the method further includes:

performing joint training of the feature extraction network and the memory neural network based on a sample video stream, the sample video stream including at least two sample shots, and each sample shot including an annotated weight.

In order to obtain an accurate weight, before the obtaining of the weight, it is necessary to train a feature extraction network and a memory neural network. Separately training the feature extraction network and the memory neural network can also achieve the purpose of the embodiments of the present disclosure. However, parameters obtained from joint training of the feature extraction network and the memory neural network are more suitable for the embodiments of the present disclosure, so that a more accurate predicted weight can be provided. The training process relates to assuming that a sample video stream is segmented into at least two sample shots, and the segmentation process may be based on a trained segmentation neural network or other means, which is not limited in some embodiments of the present disclosure.

In some embodiments, the processing of joint training includes:

performing feature extraction on each sample shot in the at least two sample shots included in the sample video stream by using the feature extraction network, to obtain at least two sample image features;

determining a predicted weight of each sample shot based on the sample shot features by using the memory neural network; and

determining a loss based on the predicated weight and the annotated weight, and adjusting parameters of the feature extraction network and the memory neural network based on the loss.

A person of ordinary skill in the art may understand that all or some operations for implementing the foregoing method embodiments may be achieved by a program by instructing related hardware; the foregoing program can be stored in a computer readable storage medium; when the program is executed, operations including the foregoing method embodiments are executed. Moreover, the foregoing storage medium includes various media capable of storing program codes, such as ROM, RAM, a magnetic disk, or an optical disk.

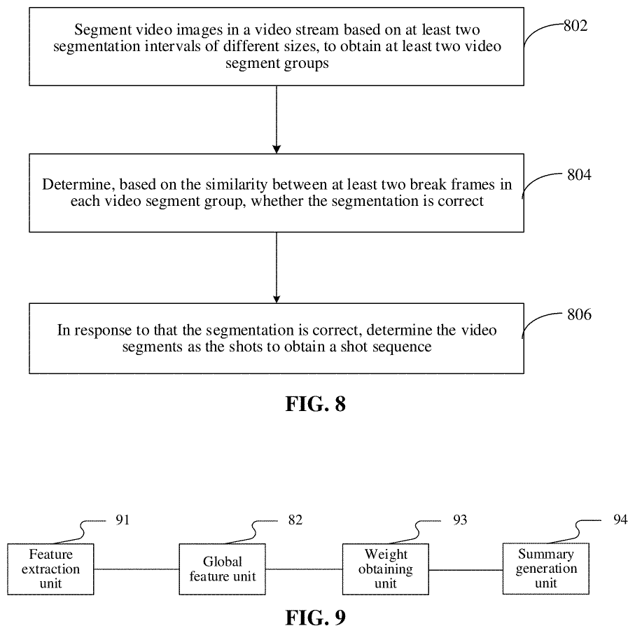

FIG. 9 is a schematic structural diagram of one embodiment of a video summary generation apparatus provided in embodiments of the present disclosure. The apparatus of the embodiment is used for implementing the foregoing method embodiments of the present disclosure. As shown in FIG. 9, the apparatus of the embodiment includes the following units.

A feature extraction unit 91, configured to perform feature extraction on a shot in a shot sequence of a video stream to be processed, to obtain an image feature of the shot.

In some embodiments, the video stream to be processed is a video stream from which a video summary is obtained, and the video stream includes at least one frame of video image. In order to make the obtained video summary have meaningful content, instead of being just an image set consisting of different frames of video images, in some embodiments of the present disclosure, the shot is used as a constituent unit of the video summary, and each shot includes at least one frame of video image. Optionally, the feature extraction in some embodiments of the present disclosure may be implemented based on any feature extraction network, i.e., the feature extraction is separately performed on each shot based on a feature extraction network to obtain at least two image features. A specific feature extraction process is not limited in the present disclosure.

A global feature unit 92, configured to obtain a global feature of the shot according to all image features of the shot.

In some embodiments, all the image features corresponding to the video stream are processed (such as mapping or embedding) to obtain a conversion feature sequence corresponding to the entire video stream, the conversion feature sequence is then calculated together with each image feature to obtain the global feature (global attention) corresponding to each shot, and an association between each shot and the other shots in the video stream can be reflected through the global feature.

A weight obtaining unit 93, configured to determine a weight of the shot according to the image feature of the shot and the global feature.

The weight of the shot is determined through the image feature of the shot and the global feature of the shot. The weight obtained thereby is based not only on the shot per se, but also on the association between the shot and the other shots in the entire video stream, thereby achieving evaluation on the importance of the video on the part of the video as a whole.

A summary generation unit 94, configured to obtain a video summary of the video stream to be processed based on the weight of the shot.

In some embodiments, the embodiments of the present disclosure reflect the importance of each shot through the weight of the shot, so that some important shots in the shot sequence can be determined. However, the video summary is determined not just based on the importance of the shot, it also requires to control the length of the video summary, i.e., it requires to determine the video summary in combination of the weight and the duration (number of frames) of the shot. Optionally, the video summary may be obtained by using a knapsack algorithm.

According to the video summary generation apparatus provided in the foregoing embodiments, a weight of each shot is determined in combination of an image feature and a global feature, such that a video is understood on the part of the video as a whole; and by using the global association between each shot and the entire video, based on the video summary determined in some embodiments, the video content can be expressed as a whole, thereby avoiding the issue of an one-sided video summary.

In one or more optional embodiments, the global feature unit 92 is configured to process the all image features of the shot based on a memory neural network to obtain the global feature of the shot.

In some embodiments, the memory neural network may include at least two embedding matrices. By respectively inputting the all image features of the shot of the video stream to the at least two embedding matrices, the global feature of each shot is obtained through an output of the embedding matrices. The global feature of the shot may reflect an association between the shot and the other shots in the video stream. In terms of a weight of the shot, the greater the weight, the greater the association between the shot and the other shots, and the more likely the shot is to be included in the video summary.

In some embodiments, the global feature unit 92 is configured to respectively map the all image features of the shot to each of a first embedding matrix and a second embedding matrix, to obtain a respective one of an input memory and an output memory; and obtain the global feature of the shot according to the image feature of the shot, the input memory, and the output memory.

In some embodiments, when obtaining the global feature of the shot according to the image feature of the shot, the input memory, and the output memory, the global feature unit 92 is configured to map the image feature of the shot to a third embedding matrix to obtain a feature vector of the shot; perform an inner product operation of the feature vector and the input memory to obtain a weight vector of the shot; and perform a weighted overlay operation of the weight vector and the output memory to obtain a global vector, and use the global vector as the global feature.

In one or more optional embodiments, the weight obtaining unit 93 is configured to perform the inner product operation of the image feature of the shot and the global feature of the shot to obtain a weight feature; and pass the weight feature through a fully connected neural network to obtain the weight of the shot.

In some embodiments, a weight of a shot is determined in combination with an image feature of the shot and a global feature of the shot, and when information of the shot is reflected, it also combines the association between the shot and a video as a whole, so that the video is understood on the part of the video partially or as a whole, thereby making the obtained video summary more in line with human habits.

In one or more optional embodiments, the global feature unit 92 is configured to process the image features of the shots based on the memory neural network to obtain at least two global features of the shot.

In some embodiments of the present disclosure, in order to improve the globality of a weight of a shot, at least two global features are obtained through at least two memory groups, and the weight of the shot is obtained in combination of multiple global features, where each embedding matrix group includes different embedding matrices or the same embedding matric, and when the embedding matrix groups are different, the obtained global features can better reflect a global association between the shot and a video.

In some embodiments, the global feature unit 92 is configured to respectively map the image features of the shots to at least two embedding matrix groups, to obtain at least two memory groups, each embedding matrix group including two embedding matrices, and each memory group including the input memory and the output memory; and obtain the at least two global features of the shot according to the at least two memory groups and the image feature of the shot.

In some embodiments, when obtaining the at least two global features of the shot according to the at least two memory groups and the image feature of the shot, the global feature unit 92 is configured to map the image feature of the shot to the third embedding matrix to obtain the feature vector of the shot; perform the inner product operation of the feature vector and at least two input memories to obtain at least two weight vectors of the shot; and perform the weighted overlay operation of the weight vectors and at least two output memories to obtain at least two global vectors, and use the at least two global vectors as the at least two global features.

In some embodiments, the weight obtaining unit 93 is configured to perform the inner product operation of the image feature of the shot and a first global feature in the at least two global features of the shot to obtain a first weight feature; use the first weight feature as the image feature, and use a second global feature in the at least two global features of the shot as the first global feature, the second global feature being a global feature other than the first global feature in the at least two global features; perform the inner product operation of the image feature of the shot and the first global feature in the at least two global features of the shot to obtain the first weight feature; use the first weight feature as the weight feature of the shot when the at least two global features of the shot do not include the second global feature; and pass the weight feature through the fully connected neural network to obtain the weight of the shot.

In one or more optional embodiments, the apparatus further includes the following units.

a shot segmentation unit, configured to perform shot segmentation on the video stream to be processed to obtain the shot sequence.

In some embodiments, shot segmentation is performed based on the similarity between at least two frames of video images in the video stream to be processed, to obtain the shot sequence.

In some embodiments, the similarity between two frames of video images can be determined through a distance (such as Euclidean distance and Cosine distance) between features corresponding to the two frames of video images. The higher the similarity between the two frames of video images, the more likely the two frames of video images belong to the same shot. In some embodiments, video images which are significantly different can be segmented to different shots though the similarity between the video images, thereby achieving accurate shot segmentation.

In some embodiments, the shot segmentation unit is configured to perform shot segmentation based on the similarity between at least two frames of video images in the video stream to be processed, to obtain the shot sequence.

In some embodiments, the shot segmentation unit is configured to segment the video images in the video stream based on each of at least two segmentation intervals of different sizes, to obtain a respective one of at least two video segment groups, each video segment group including at least two video segments, and the segmentation interval being greater than or equal to one frame; determine, based on the similarity between at least two break frames in each video segment group, whether the segmentation is correct, the break frame being a first frame in the video segment; and in response to that the segmentation is correct, determine the video segments as the shots to obtain the shot sequence.

In some embodiments, when determining, based on the similarity between at least two break frames in each video segment group, whether the segmentation is correct, the shot segmentation unit is configured to in response to that the similarity between the at least two break frames is less than or equal to a set value, determine that the segmentation is correct; and in response to that the similarity between the at least two break frames is greater than the set value, determine that the segmentation is incorrect.

In some embodiments, when in response to that the segmentation is correct, determining the video segments as the shots to obtain the shot sequence, the shot segmentation unit is configured to in response to that the break frames correspond to the at least two segmentation intervals, use the video segments obtained with the smaller segmentation interval as the shots to obtain the shot sequence.

In one or more optional embodiments, the feature extraction unit 91 is configured to perform feature extraction on at least one frame of video image in the shot to obtain at least one image feature; and obtain a mean feature of all the image features, and use the mean feature as the image feature of the shot.

In some embodiments, the feature extraction is separately performed on each frame of video image in the shot through a feature extraction network. When one shot includes only one frame of video image, the image feature is used as the image feature, and when multiple frames of video images are included, a means of the multiple image features is calculated, and a mean feature is used as the image feature of the shot.

In one or more optional embodiments, the summary generation unit is configured to obtain a limited duration of the video summary; and obtain the video summary of the video stream to be processed according to the weight of the shot and the limited duration of the video summary.

Video summary, also known as video synthesis, is a brief summary of video content. It can reflect the main content expressed in a video in a short period of time. It is necessary to limit the duration of the video summary while expressing the main content of the video, otherwise, the brief effect will not be yielded and there is no difference from watching the full video. In some embodiments of the present disclosure, the duration of the video summary is limited through a limited duration, i.e., the duration of the obtained video summary is required to be less than or equal to the limited duration, and the specific value of the limited duration can be set according to an actual situation.

In one or more embodiments, the apparatus in some embodiments of the present disclosure further includes:

a joint training unit, configured to perform joint training of the feature extraction network and the memory neural network based on a sample video stream, the sample video stream including at least two sample shots, and each sample shot including an annotated weight.

In order to obtain an accurate weight, before the obtaining of the weight, it is necessary to train a feature extraction network and a memory neural network. Separately training the feature extraction network and the memory neural network can also achieve the purpose of the embodiments of the present disclosure. However, parameters obtained from joint training of the feature extraction network and the memory neural network are more suitable for the embodiments of the present disclosure, so that a more accurate predicted weight can be provided. The training process relates to assuming that a sample video stream is segmented into at least two sample shots, and the segmentation process may be based on a trained segmentation neural network or other means, which is not limited in some embodiments of the present disclosure.

An electronic device further provided according to another aspect of embodiments of the present disclosure includes a processor, where the processor includes the video summary generation apparatus provided according to any one of the foregoing embodiments.

An electronic device further provided according to still another aspect of embodiments of the present disclosure includes: a memory, configured to store executable instructions; and

a processor, configured to communicate with the memory to execute the executable instructions so as to complete operations of the video summary generation method according to any one of the foregoing embodiments.

A computer storage medium further provided according to yet another aspect of embodiments of the present disclosure is configured to store computer readable instructions, where when the instructions are executed, operations of the video summary generation method according to any one of the foregoing embodiments are executed.

A computer program product further provided according to another aspect of embodiments of the present disclosure includes a computer readable code, where when the computer readable code runs on a device, a processor in the device executes instructions for implementing the video summary generation method according to any one of the foregoing embodiments.

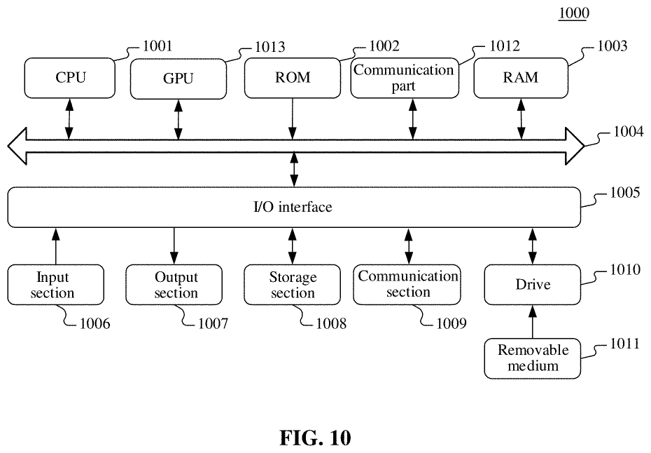

The embodiments of the present disclosure further provide an electronic device which, for example, is a mobile terminal, a Personal Computer (PC), a tablet computer, a server, or the like. Referring to FIG. 10 below, a schematic structural diagram of an electronic device 1000, which may be a terminal device or a server, suitable for implementing the embodiments of the present disclosure, is shown. As shown in FIG. 10, the electronic device 1000 includes one or more processors, a communication part, and the like. The one or more processors are, for example, one or more Central Processing Units (CPUs) 1001 and/or one or more dedicated processors; the dedicated processors may be used as an acceleration unit 1013, and may include, but not limited to, dedicated processors such as an image processor (GPU), FPGA, DSP, other ASIC chips, and the like; the processor may execute appropriate actions and processing according to executable instructions stored in a Read-Only Memory (ROM) 1002 or executable instructions loaded from a storage section 1008 to a Random Access Memory (RAM) 1003. The communication part 1012 may include, but is be limited to, a network card. The network card may include, but is not limited to, an Infiniband (IB) network card.

The processor may communicate with the ROM 1002 and/or the RAM 1003 to execute executable instructions, is connected to the communication part 1012 by means of a bus 1004, and communicates with other target devices by means of the communication part 1012, so as to complete corresponding operations of any of the methods provided by the embodiments of the present disclosure, for example, performing feature extraction on a shot in a shot sequence of a video stream to be processed, to obtain an image feature of the shot, each shot including at least one frame of video image; obtaining a global feature of the shot according to all image features of the shot; determining a weight of the shot according to the image feature of the shot and the global feature; and obtaining a video summary of the video stream to be processed based on the weight of the shot.

In addition, the RAM 1003 further stores various programs and data required for operations of an apparatus. The CPU 1001, the ROM 1002, and the RAM 1003 are connected to each other via the bus 1004. In the presence of the RAM 1003, the ROM 1002 is an optional module. The RAM 1003 stores executable instructions, or writes the executable instructions into the ROM 1002 during running, where the executable instructions cause the CPU 1001 to execute corresponding operations of the foregoing communication method. An Input/Output (I/O) interface 1005 is also connected to the bus 1004. The communication part 1012 may be integrated, or may be configured to have multiple sub-modules (for example, multiple IB network cards) connected to the bus.

The following components are connected to the I/O interface 1005: an input section 1006 including a keyboard, a mouse and the like; an output section 1007 including a Cathode-Ray Tube (CRT), a Liquid Crystal Display (LCD), a speaker and the like; a storage section 1008 including a hard disk and the like; and a communication section 1009 of a network interface card including an LAN card, a modem and the like. The communication section 1009 performs communication processing via a network such as the Internet. A drive 1010 is also connected to the I/O interface 1005 according to requirements. A removable medium 1011 such as a magnetic disk, an optical disk, a magneto-optical disk, and a semiconductor memory is installed on the drive 1010 according to requirements, so that a computer program read from the removable medium is installed on the storage section 1008 according to requirements.

It should be noted that, the architecture shown in FIG. 10 is merely an optional implementation. During specific practice, the number and types of the components in FIG. 10 may be selected, decreased, increased, or replaced according to actual requirements. Different functional components may be separated or integrated or the like. For example, the acceleration unit 1013 and the CPU 1001 may be separated, or the acceleration unit 1013 may be integrated on the CPU 1001, and the communication part may be separated from or integrated on the CPU 1001 or the acceleration unit 1013 or the like. These alternative implementations all fall within the scope of protection of the present disclosure.

Particularly, the process described above with reference to the flowchart according to the embodiments of the present disclosure may be implemented as a computer software program. For example, the embodiments of the present disclosure provide a computer program product, which includes a computer program tangibly included in a machine readable medium. The computer program includes a program code for executing a method shown in the flowchart. The program code may include corresponding instructions for correspondingly executing operations of the methods provided by the embodiments of the present disclosure, such as performing feature extraction on a shot in a shot sequence of a video stream to be processed, to obtain an image feature of the shot, each shot including at least one frame of video image; obtaining a global feature of the shot according to all image features of the shot; determining a weight of the shot according to the image feature of the shot and the global feature; and obtaining a video summary of the video stream to be processed based on the weight of the shot. In such embodiments, the computer program is downloaded and installed from the network through the communication section 1009, and/or is installed from the removable medium 1011. The computer program, when being executed by the CPU 1001, executes the operations of the foregoing functions defined in the methods of the present disclosure.

The methods and apparatuses in the present disclosure may be implemented in many manners. For example, the methods and apparatuses in the present disclosure may be implemented with software, hardware, firmware, or any combination of software, hardware, and firmware. The foregoing specific sequence of operations of the method is merely for description, and unless otherwise stated particularly, is not intended to limit the operations of the method in the present disclosure. In addition, in some embodiments, the present disclosure is also implemented as programs recorded in a recording medium. The programs include machine-readable instructions for implementing the methods according to the present disclosure. Therefore, the present disclosure further covers the recording medium storing the programs for performing the methods according to the present disclosure.

The descriptions of the present disclosure are provided for the purpose of examples and description, and are not intended to be exhaustive or limit the present disclosure to the disclosed form. Many modifications and changes are obvious to a person of ordinary skill in the art. The embodiments are selected and described to better describe a principle and an actual disclosure of the present disclosure, and to make a person of ordinary skill in the art understand the present disclosure, so as to design various embodiments with various modifications applicable to particular use.

What is claimed is:

1. A video summary generation method, comprising:
performing feature extraction on each shot in a shot sequence of a video stream to be processed, to obtain an image feature of the shot, the shot comprising at least one frame of video image;
obtaining a global feature of the shot according to all image features of the shot;
determining a weight of the shot according to the image feature of the shot and the global feature; and
obtaining a video summary of the video stream to be processed based on the weight of the shot.

2. The method according to claim 1, wherein the obtaining a global feature of the shot according to all image features of the shot comprises:
processing the all image features of the shot based on a memory neural network to obtain the global feature of the shot.

3. The method according to claim 2, wherein the processing the all image features of the shot based on a memory neural network to obtain the global feature of the shot comprises:
mapping the all image features of the shot to each of a first embedding matrix and a second embedding matrix to obtain a respective one of an input memory and an output memory; and
obtaining the global feature of the shot according to the image feature of the shot, the input memory, and the output memory.

4. The method according to claim 3, wherein the obtaining the global feature of the shot according to the image feature of the shot, the input memory, and the output memory comprises:
mapping the image feature of the shot to a third embedding matrix to obtain a feature vector of the shot;
performing an inner product operation of the feature vector and the input memory to obtain a weight vector of the shot; and
performing a weighted overlay operation of the weight vector and the output memory to obtain a global vector, and using the global vector as the global feature.

5. The method according to claim 1, wherein the determining a weight of the shot according to the image feature of the shot and the global feature comprises:
performing an inner product operation of the image feature of the shot and the global feature of the shot to obtain a weight feature; and
processing the weight feature by a fully connected neural network to obtain the weight of the shot.

6. The method according to claim 2, wherein the processing the all image features of the shot based on a memory neural network to obtain the global feature of the shot comprises:
processing the all image features of the shot based on the memory neural network to obtain at least two global features of the shot.

7. The method according to claim 6, wherein the processing the all image features of the shot based on the memory neural network to obtain at least two global features of the shot comprises:
mapping the all image features of the shot to each of at least two embedding matrix groups to obtain a respective one of at least two memory groups, each of the at least two embedding matrix groups comprising two embedding matrices, and each of the at least two memory groups comprising an input memory and an output memory; and
obtaining the at least two global features of the shot according to the at least two memory groups and the image feature of the shot.

8. The method according to claim 7, wherein the obtaining the at least two global features of the shot according to the at least two memory groups and the image feature of the shot comprises:
mapping the image feature of the shot to a third embedding matrix to obtain a feature vector of the shot;
performing an inner product operation of the feature vector and at least two input memories to obtain at least two weight vectors of the shot; and
performing a weighted overlay operation of the at least two weight vectors and at least two output memories to obtain at least two global vectors, and using the at least two global vectors as the at least two global features.

9. The method according to claim 6, wherein the determining a weight of the shot according to the image feature of the shot and the global feature comprises:
performing an inner product operation of the image feature of the shot and a first global feature in the at least two global features of the shot to obtain a first weight feature;
using the first weight feature as the image feature, and using a second global feature in the at least two global features of the shot as the first global feature, the second global feature being a global feature other than the first global feature in the at least two global features;
performing the inner product operation of the image feature of the shot and the first global feature in the at least two global features of the shot to obtain the first weight feature;
using the first weight feature as the weight feature of the shot when the at least two global features of the shot do not comprise the second global feature; and
performing the weight feature by a fully connected neural network to obtain the weight of the shot.

10. The method according to claim 1, further comprising, before the performing feature extraction on each shot in a shot sequence of a video stream to be processed, to obtain an image feature of the shot:
performing shot segmentation on the video stream to be processed to obtain the shot sequence.

11. The method according to claim 10, wherein the performing shot segmentation on the video stream to be processed to obtain the shot sequence comprises:
performing shot segmentation based on a similarity between at least two frames of video images in the video stream to be processed, to obtain the shot sequence.

12. The method according to claim 11, wherein the performing shot segmentation based on a similarity between at least two frames of video images in the video stream to be processed, to obtain the shot sequence comprises:
segmenting the at least two frames of video images in the video stream based on each of at least two segmentation intervals of different sizes, to obtain a respective one of at least two video segment groups, each of the at least two video segment groups comprising at least two video segments, and each of the at least two segmentation intervals being greater than or equal to one frame;
determining, based on a similarity between at least two break frames in each of the at least two video segment groups, whether the segmentation is correct, each of the at least two break frame being a first frame in the video segment; and
in response to the segmentation being correct, determining the video segments as the shots to obtain the shot sequence.

13. The method according to claim 12, wherein the determining, based on a similarity between at least two break frames in each of the at least two video segment groups, whether the segmentation is correct comprises:
in response to the similarity between the at least two break frames being less than or equal to a set value, determining that the segmentation is correct; and
in response to the similarity between the at least two break frames being greater than the set value, determining that the segmentation is incorrect.

14. The method according to claim 12, wherein the in response to the segmentation being correct, determining the video segments as the shots to obtain the shot sequence comprises:
in response to one break frames corresponding to the at least two segmentation intervals, using the video segment obtained with a smaller segmentation interval as the shot to obtain the shot sequence.

15. The method according to claim 1, wherein the performing feature extraction on each shot in a shot sequence of a video stream to be processed, to obtain an image feature of the shot comprises:
performing feature extraction on at least one frame of video image in the shot to obtain at least one image feature; and
obtaining a mean feature of all the at least one image feature, and using the mean feature as the image feature of the shot.

16. The method according to claim 1, wherein the obtaining a video summary of the video stream to be processed based on the weight of the shot comprises:
obtaining a limited duration of the video summary; and
obtaining the video summary of the video stream to be processed according to the weight of the shot and the limited duration of the video summary.

17. The method according to claim 1, wherein the method is implemented based on a feature extraction network and a memory neural network; and
before the performing feature extraction on each shot in a shot sequence of a video stream to be processed, to obtain an image feature of the shot, the method further comprises: performing joint training of the feature extraction network and the memory neural network based on a sample video stream, the sample video stream comprising at least two sample shots, and each of the at least two sample shots comprising an annotated weight.

18. An electronic device, comprising: a memory, configured to store executable instructions; and
a processor, configured to communicate with the memory to execute the executable instructions, when the executable instructions are executed by the processor, the processor is configured to:
perform feature extraction on each shot in a shot sequence of a video stream to be processed, to obtain an image feature of the shot, the shot comprising at least one frame of video image;
obtain a global feature of the shot according to all image features of the shot;
determine a weight of the shot according to the image feature of the shot and the global feature; and
obtain a video summary of the video stream to be processed based on the weight of the shot.

19. The electronic device according to claim 18, wherein the processor is further configured to:
process the all image features of the shot based on a memory neural network to obtain the global feature of the shot.

20. A non-transitory computer storage medium, configured to store computer readable instructions, wherein when the instructions are executed, the following operations are executed:
performing feature extraction on each shot in a shot sequence of a video stream to be processed, to obtain an image feature of the shot, the shot comprising at least one frame of video image;
obtaining a global feature of the shot according to all image features of the shot;
determining a weight of the shot according to the image feature of the shot and the global feature; and
obtaining a video summary of the video stream to be processed based on the weight of the shot.
